(19) United States
(12) Patent Application Publication
(10) Pub. No.: US 2006/0187807 A1
(43) Pub. Date: Aug. 24, 2006

(54) Optical disc having focus offset area

(75) Inventors: Wilhelmus Robert Koppers, Eindhoven (NL); Pierre Hermanus Woerlee, Eindhoven (NL); Hubert Cecile Francois Martens, Eindhoven (NL); Ronald Joseph Antonius Van Den Oetelaar, Eindhoven (NL); Johannus Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/549,644

(22) PCT Filed: Mar. 11, 2004
(86) PCT No.: PCT/IB04/50229

§ 371 Date: Sep. 20, 2005

(30) Foreign Application Priority Data
Mar. 24, 2003 (EP) 03100751.1

(51) Int. Cl. G11B 7/24

(52) U.S. Cl. 369/275.1

(57) ABSTRACT

A record carrier is for recording information by writing marks in a track on a recording layer. The shortest mark used for recording the information has a length of a predefined minimum number d of channel bit lengths. The record carrier (11) has a pregroove that is modulated by a carrier pattern containing long marks (18,19) that provides a focus area (12) at a predefined location on the recording layer. The long marks have lengths of at least two times the length of the shortest mark for being substantially longer than the effective diameter of the scanning spot. A scanning device locates the focus area and determines the best focus offset by detecting the maximum read signal amplitude while scanning the carrier pattern.

The invention relates to a record carrier of a writable type for recording information by writing marks in a track.

The invention further relates to a device for scanning the record carrier.

US Patent Application US2002/0150005 describes a record carrier comprising a guide groove, usually called pregroove, for indicating the position of tracks in which the information is to be represented in a predefined manner by recording optically readable marks. The pregroove is meandering by a periodic excursion of the track in a transverse direction (further denoted as wobble). The wobble may be varied in period according to additional information such as addresses. The corresponding scanning device has auxiliary detectors for generating tracking servo signals based on the wobble for detecting a spatial deviation of the head with respect to the track. The tracking servo signals are used to control actuators to position the head on the track. The variations in period of the wobble are detected for retrieving the auxiliary information, e.g. address information. For focusing the beam the device performs a focus adjustment function by reading a focus area provided with pre-produced data patterns. The servo offset is adjusted based on an error rate or jitter value of a read-out signal during scanning the data patterns. The pre-produced data patterns have to be applied on the record carrier during manufacture of the record carrier. As such pre-produced data patterns are different from the pregroove, additional production steps are required.

Therefore it is an object of the invention to provide a record carrier and a scanning device for adjusting the focusing of a scanning beam which do not require a pre-produced data pattern for adjusting the focus offset.

According to a first aspect of the invention the object is achieved with a record carrier of a writable type for recording information by writing marks in a track on a recording layer via a beam of radiation entering through an entrance face of the record carrier and constituting a scanning spot having an effective diameter on the track, the marks having lengths corresponding to an integer number of channel bit lengths T and the shortest marks having a length of a predefined minimum number d of channel bit lengths T for being detectable via the scanning spot having said effective diameter, the recording layer comprising a pregroove for indicating the track, the pregroove exhibiting a wobble constituted by displacements of the pregroove in a direction transverse to the longitudinal direction of the track, and the pregroove comprising a pregroove modulation of the depth and/or width of pregroove areas for constituting a carrier pattern containing long marks, the long marks having lengths of at least two times the predefined minimum number d of channel bit lengths T for being substantially longer than the effective diameter of the scanning spot, and the carrier pattern constituting a focus area at a predefined location on the recording layer.

According to a second aspect of the invention the object is achieved with a device for scanning a track on the above mentioned record carrier via a beam of radiation, the device comprising a head for providing the beam, focus servo means for focusing the beam on the track for constituting said scanning spot, a front-end unit for generating a scanning signal for detecting marks in the track, and a focus adjustment unit for locating the focus area and for adjusting the focus servo means in dependence on an amplitude of the scanning signal due to the carrier pattern during scanning the focus area.

This has the advantage that the carrier pattern is produced during manufacture of the record carrier using the same production steps already used for producing the pregroove. The effect of including the long marks in the carrier pattern is that the focus offset that is detected based on the maximum amplitude of the scanning signal corresponds substantially to the optimum focus offset. The long marks are substantially longer than the effective diameter of the scanning spot, which effective diameter is effective for reading out marks from at least a predefined minimum size, and is usually defined as the diameter at which the intensity of radiation is down 50% of its peak value.

The invention is also based on the following recognition. In high density optical recording focus offset is used to improve the read-out signal, which for example may be impaired due to optical aberration effects caused by a non-ideal depth position of the recording layer. Jitter is generally known to be an indicator for errors occurring during read-out of marks that represent user data according to a channel coding using different mark lengths. Hence jitter may be measured when a data pattern is available. However the inventors considered omitting the prewritten data pattern and applying a pregroove modulation to provide a focus pattern. The amplitude and quality of the read-out signal of the pregroove modulation proved to be relatively low. Hence jitter measurements are impractical. Surprisingly it was found that a maximum value of a push pull signal (usually detected from the pregroove for positioning the head on the track at the correct focus) does also not correspond to the best focus offset. The inventors have seen that when applying amplitude measurements on a pregroove modulation pattern for determining focus offset, the maximum amplitude does not necessarily coincide with the best offset value. In particular deviations of maximum amplitude and best focus were found when using short marks. Hence the carrier pattern includes sufficient long marks for detecting the amplitude due to the long marks.

In an embodiment the record carrier comprises at least a first recording layer and a second recording layer, the first recording layer being present at a position closer to the entrance face than the second recording layer, and each recording layer having the focus pattern. This has the advantage that the focus offset for each layer is adjustable via the respective focus pattern. In particular effects from stray light from the layer which is out of focus can be corrected by maximizing the amplitude of the signal due to the carrier pattern containing long marks.

In an embodiment of the record carrier the carrier pattern substantially only contains said long marks. Such a carrier pattern is mainly constituted by long marks, i.e. a pattern having at least 50% marks that are long with respect to the effective diameter of the scanning spot. Advantageously such a carrier pattern provides maximum signal amplitude, which corresponds to the best focus offset.

It is noted that European Patent Application EP 1 136 988 describes an optical recording medium comprising focus test patterns of marks in a focus area. In particular the test patterns are constituted by short marks, such as 2 T or 3 T. User data is recorded using a run length limited code, such as the RLL (1, 7) code, wherein at least 1 and at most 7 channel bits of a same signal value are between signal transitions, resulting in marks of 2 to 8 channel bit lengths (2 T to 8 T). For focusing a scanning beam a device performs a focus adjustment function and determines a focus offset by reading the focus test patterns. The focus servo gain is adjusted based on amplitude differences of a read-out signal at different read focus offsets. In the current invention the carrier pattern in the focus area is constituted by pregroove modulation that contains said long marks.

Further preferred embodiments of the device according to the invention are given in the further claims.

These and other aspects of the invention will be apparent from and elucidated further with reference to the embodiments described by way of example in the following description and with reference to the accompanying drawings, in which

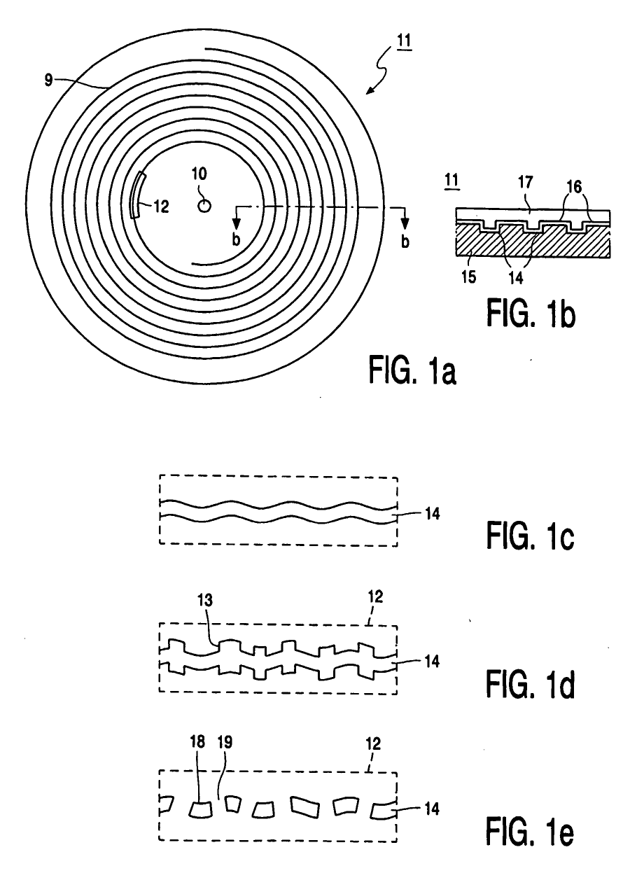

FIG. 1a shows a disc-shaped record carrier,

FIG. 1b shows a cross-section taken of the record carrier,

FIG. 1c shows an example of a wobble of the track,

FIG. 1d shows a wobble having a pregroove modulation by variations of the width,

FIG. 1e shows a wobble having a pregroove modulation by variations of the depth,

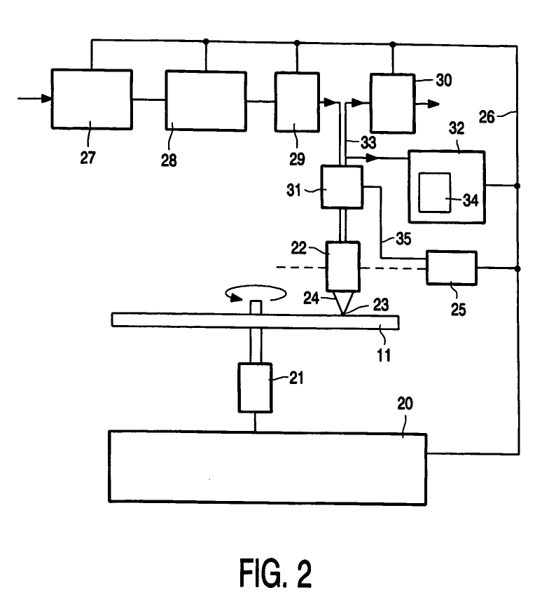

FIG. 2 shows a scanning device having focus adjustment,

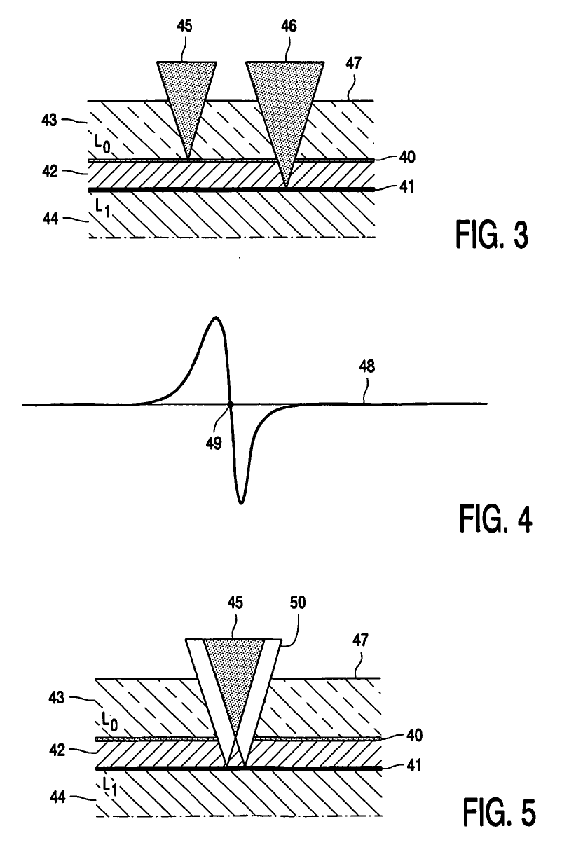

FIG. 3 shows a multilayer optical disc,

FIG. 4 shows the focus error signal S-curve,

FIG. 5 shows a multilayer optical disc and stray light,

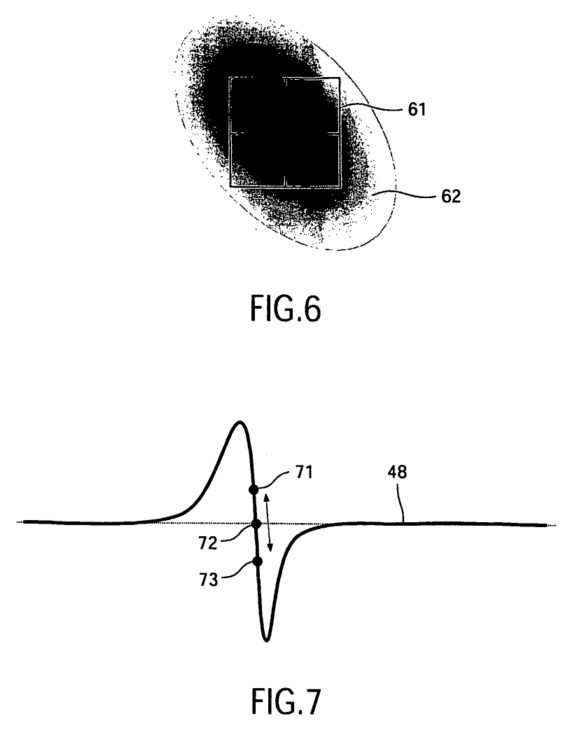

FIG. 6 shows reflected light on a detector,

FIG. 7 shows the focus error signal S-curve and focus offset,

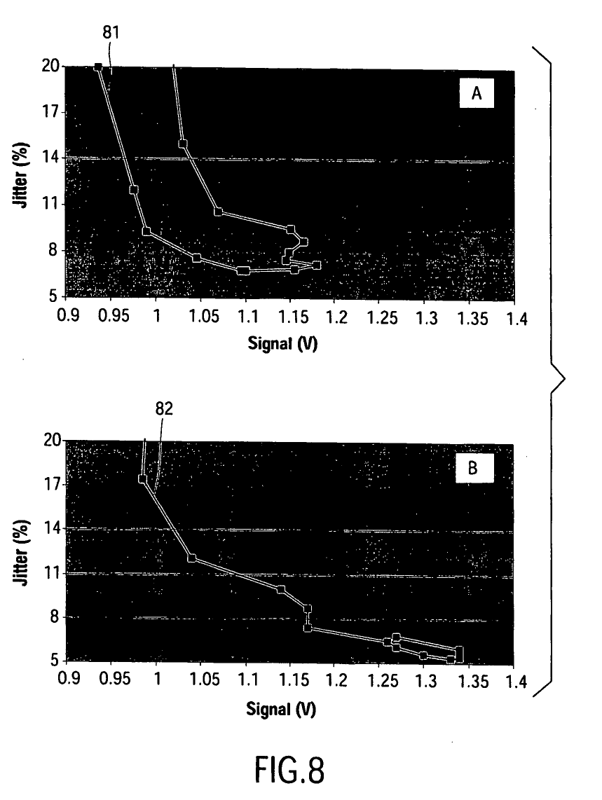

FIG. 8 shows jitter values for a dual layer disc,

FIG. 9 shows a read signal as a function of focus-offset for the L1 layer of a dual layer disc, and

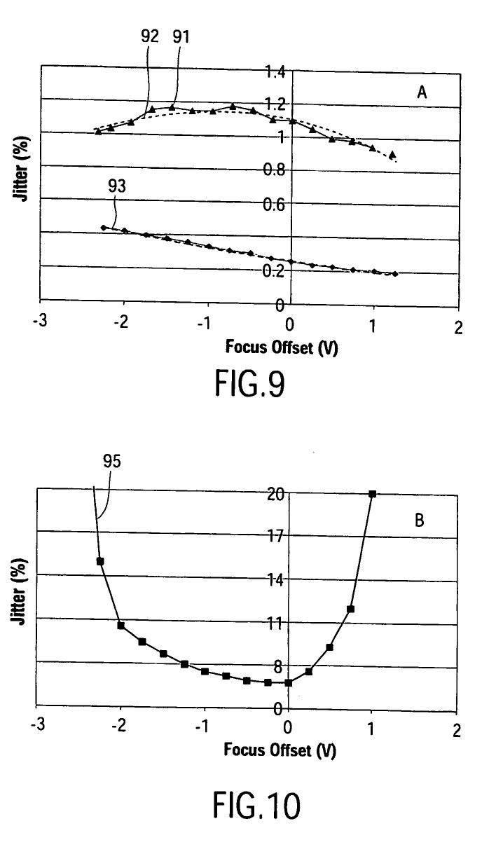

FIG. 10 shows the jitter as a function of focus-offset for the L1 layer of a dual layer disc.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CD-R and CD-RW, and the DVD+RW. The track 9 on the recordable type of record carrier is indicated by a pre-embossed track structure provided during manufacture of the blank record carrier, for example a pregroove. Recorded information is represented on the information layer by optically detectable marks recorded along the track. The marks are constituted by variations of a first physical parameter and thereby have different optical properties than their surroundings, e.g. variations in reflection.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A track structure may also be formed by regularly spread sub-tracks which periodically cause servo signals to occur. The record carrier may be intended to carry real-time information, for example video or audio information, or other information, such as computer data.

FIG. 1c shows an example of a wobble of the track. The Figure shows a periodic variation of the lateral position of the track, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the prior art wobble as shown in FIG. 1c in a writable CD system comprising disc information encoded in such a manner can be found in U.S. Pat. No. 4,901,300 (PHN 12.398) and U.S. Pat. No. 5,187,699 (PHQ 88.002).

During readout by scanning the track modulation of the wobble is detectable via a second type of variations of the radiation, such as variation of intensity in the cross section of the reflected beam detectable by detector segments or additional detectors for generating tracking servo signals. Detecting the wobble for a tracking servo system is well known from the above mentioned CD-R and CD-RW system.

User data can be recorded on the record carrier by marks having discrete lengths in unit called channel bits, for example according to the CD or DVD channel coding scheme. The marks are having lengths corresponding to an integer number of channel bit lengths T. The shortest marks that are used have a length of a predefined minimum number d of channel bit lengths T for being detectable via the scanning spot on the track that has an effective diameter, usually being roughly equal to the length of the shortest mark.

According to the invention the record carrier has a focus area 12 at a predefined location on the recording layer. The predefined position is indicated schematically as a part of the track 9 by the rectangle 12 in the Figure, but in practice the focus area has sufficient length for allowing a maximum read signal to be determined, e.g. a few windings of the track. Usually the focus area can be located when the focus is not yet optimized, e.g. addresses can be detected from the pregroove.

In an embodiment the predefined position is an area covering a predefined radial range to allow a device to locate the focus area based on the radial positioning of the optical head without the need to read the addresses in the track.

The focus area 12 is provided for performing a focus adjustment procedure as discussed below for setting a best focus offset, which results in a low jitter in the read-out signal of the user data. The focus area 12 is provided with a carrier pattern containing long marks during manufacture of the record carrier. The carrier pattern is a series of prewritten marks that includes marks that are long compared to the length of the shortest mark used for user data encoding for being substantially longer than the effective diameter of the scanning spot. In particular the long marks have lengths of at least two times the predefined minimum number d of channel bit lengths T. In various embodiments the carrier pattern may be constituted by long marks having a single length, or may be a predefined pattern using a few lengths, or may be randomly varied or may be modulated for encoding further information.

In an embodiment of the invention the shortest marks for recording the main information have a length of a 3 channel bit lengths, usually denoted as d=3 T or 3I. For example in DVD the channel code is an RLL (2, 10) code having a minimum length of 3 T, and a maximum length of 11 T, while marks of 14 T are used for synchronization. In such a system the long marks have at least a length of 6 T or 7 T, but preferably have lengths of at least 8 T. A practical single tone carrier pattern has long marks of a single size, e.g. pits and intermediate lands having a length of 11 T. It is noted that for a wobble corresponding to a predefined number of channel bit lengths suitable pregroove mark lengths are selected to constitute a pattern fitting that predefined number. For a wobble of 32 channel bits like in DVD+RW, a suitable length is 8 T pregroove pits alternating with 8 T pregroove lands. Suitable ranges of lengths for encoding information in the long marks are a range of 6 T to 14 T, or 10 T to 12 T.

In an embodiment of the invention the record carrier is provided an area of pits and lands like prerecorded data on read-only record carrier for constituting the focus area with the carrier pattern. The pits and lands are long compared to the shortest user data pits as indicated above.

According to an embodiment of the invention the pregroove is provided with a pregroove modulation constituted by variations of a physical parameter related to the shape of the pregroove as discussed below.

FIG. 1d shows a wobble having a pregroove modulation by variations of the width. The Figure shows the wobbled pregroove 14 having a pregroove modulation 13. The shape of the pregroove, being the local cross-sectional shape, is changed according to an additional information signal to be encoded. Such change in shape affects the radiation reflected from the track during scanning, and can be detected thereby. As shown in the Figure the width of the pregroove is modulated according to a digital modulation pattern.

FIG. 1e shows a wobble having a pregroove modulation by variations of the depth. As shown the depth is varied digitally for constituting pregroove pit areas 18 having a predefined depth and pregroove land areas 19 having a zero depth (i.e. no pregroove is present). Other variations of depth may be used instead.

For manufacture of such a record carrier a master disc is made. During the mastering process, the pregroove is written by a laser beam recorder. The wobble is made by imposing a small lateral offset of the nominal centre position of the track, and the intensity of the laser power of the mastering laser beam is further modulated to provide the pregroove shape modulation.

In an embodiment the pregroove (width, depth) modulation along the track is used to generate an additional data channel. The unrecorded disc (R or RW type) then contains additional mastered data, for example recording control data. The additional data may be encoded using a channel code similar or equal to the channel code used to encode the main user data. This has the advantage that no additional circuitry is needed for decoding the additional data. In an embodiment a different modulation is used, i.e. a channel modulation code differing from the channel code used to encode the main user data. This allows any modulation to be used for encoding information in the pregroove that is optimized for not disturbing the other properties of the pregroove, e.g. a modulation having ‘constant length pulses’ encoding the additional data by the position of the pulses.

In an embodiment the focus area is located in an area that, according to a required standardized format like DVD, does not contain relevant HF data, for example in the lead-out zone or in the middle zone.

In an embodiment the additional data in the pregroove is modulated for distinguishing the additional data from superimposed high-frequency main user data, e.g. run length-modulated, frequency-modulated, amplitude-modulated, phase-modulated, or any other modulation scheme, which is different from the modulation of the main user data.

FIG. 2 shows a scanning device having focus adjustment. The device is provided with means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The main scanning signal 33 is processed by read processing unit 30 of a usual type including a demodulator, deformatter and output unit to retrieve the information.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

The device has a focus adjustment unit 32 for locating the focus area and for adjusting the focus servo unit 25. The best focus is detected by scanning the carrier pattern in the focus area as described below. The amplitude of the scanning signal due to said long marks is detected during scanning the focus area. In particular a maximum of the amplitude is found by varying the focus offset. The focus adjustment unit may also be implemented as a software function in the control unit 20, using the read circuitry available in the read unit 30 for detecting the amplitude of the signal due to the long marks. The control unit 20 controls the focus servo unit 25 and other read-out functions for performing a focus adjustment function as discussed in detail below.

In an embodiment the device has a pregroove demodulation unit 34 for detecting pregroove modulation in the scanning signal as follows. The main scanning signal 33 is received from the front-end unit 31. Recording control information is retrieved from the pregroove modulation by the pregroove demodulation unit 34. Timing recovery for reconstructing a data clock of the auxiliary signal can be based on the wobble frequency or on the pregroove modulation itself. In an embodiment timing recovery is based on the data clock retrieved for the main data. Synchronous detection can be applied for detecting the data bits of the auxiliary data. In an embodiment the pregroove modulation is provided with a channel code and/or error correction codes different from the channel codes used in the user data, and the demodulation unit 34 is provided with a dedicated channel code demodulator and/or error correction unit. In an embodiment components in the signal 33 due to the marks of the main information are removed and components due to the marks of the pregroove modulation are isolated, e.g. by a filter unit that has a low pass or band pass function specifically tuned to the long marks.

In an embodiment the device is provided with recording means for recording information on a record carrier of a writable or re-writable type, for example CD-R or CD-RW, or DVD+RW or BD. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the beam of radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

Writing and reading of information for recording on optical disks and formatting, error correcting and channel coding rules are well-known in the art, e.g. from the CD or DVD system. In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The focus adjustment unit 32, the focus servo unit 25 and the control unit 20 are performing the focus adjustment function of finding the optimal focus-offset. First the focus area is located and the head is positioned on the track in the focus area. Subsequently the carrier pattern of long marks is scanned and the read signal amplitude is detected for a range of focus offset values. The maximum signal value indicates the best focus offset value, which focus offset value is stored in an offset adjustment setting in the focus servo unit. In an embodiment the focus adjustment function is performed for a multilayer disc for each of the relevant layers separately. The focus area on the respective layer is located, and the further steps are performed as indicated above for the first layer. Finding the right focus offset is important for writing recordable and rewritable discs. With a non-optimal focus offset the data is written on the disc in a non-optimal manner, leading to increased jitter values (especially during read out).

In an embodiment of the device main user data, also called high-frequency (HF) data, is superimposed on the modulated pregroove. This may be required for example for compatibility with a standard like DVD-ROM for creating a lead-in or lead-out area. It is noted that the area containing the pregroove modulation and HF data may show a degraded HF read-out signal. Also the pregroove modulation may be no longer detectable after superimposing. In an embodiment of the device the focus adjustment unit 32 is arranged for, as soon as recorded data is available on the record carrier, adjusting the focusing based on measurements of that data such as jitter, error rate or amplitude.

Writable and rewritable optical storage for video and data applications is a rapidly growing market. For DVD+R/+RW the storage capacity is 4.7 Gbyte, which is a limited amount of storage for video recording and data applications. More data storage capacity is desirable. An option is to use optical discs with multiple information layers.

FIG. 3 shows a multilayer optical disc. L0 is a first recording layer 40 and L1 is a second recording layer 41. A first transparent layer 43 covers the first recording layer, a spacer layer 42 separates both recording layers 40,41 and a substrate layer 44 is shown below the second recording layer 41. The first recording layer 40 is located at a position closer to an entrance face 47 of the record carrier than the second recording layer 41. A laser beam is shown in a first state 45 focused on the L0 layer and the laser beam is shown in a second state 46 focused at the L1 layer. Each recording layer has the focus pattern.

Multilayer discs are already available as read-only pre-recorded discs, such as DVD-ROM or DVD-Video. A dual layer DVD+R disc has recently been suggested, which disc should preferably be compatible with the dual layer DVD-ROM standard. The reflection levels of both layers are >18%. The L0 layer has a transmission around 50-70%. A spacer layer separates the layers with a typical thickness between 30 and 60 μm. The L1 layer has a high reflection and needs to be very sensitive. Also rewritable dual-layer discs are proposed. The L0 layer has a transmission around 40-60%. The effective reflection of both layers is typically 7% although lower and higher values are possible (3%-18%). Writable and rewritable optical storage media having 3 or more recording layers are considered also.

FIG. 4 shows the focus error signal S-curve. The focus error signal 48 is shown for a focus varied from below to above a recording layer. For example in single layer +RW and ROM, the optimal focus-offset is found by keeping the focus-error at the zero crossing 49 of the S-curve. Additional fine-tuning may be provided by optimizing on pre-recorded data (in the case of the ROM disc). In dual layer DVD-ROM (DVD-9), the optimal focus-offset is found by keeping the focus-error at the zero crossing of the S-curve and then subsequently further optimizing the focus offset by minimizing the jitter of the read out signal. Here, the optimal focus-offset suffers from stray light from the other out-of focus layer and from aberrations due to the, in general, non-ideal depth of the in-focus layer, but this can be compensated by optimizing on jitter. In (unrecorded) dual layer DVD+R/+RW no pre-recorded data is available to optimize the jitter values.

FIG. 5 shows a multilayer optical disc and stray light. L0 is a first recording layer 40 and L1 is a second recording layer 41. The laser beam 45 is shown focused on the L0 layer. Stray light 50 is shown reflecting from the second layer L1 that is out of focus. In dual layer discs there is a problem of finding the optimal focus-offset value for writing while there is no pre-recorded data present and the focus offset suffers from the non-uniform stray light 50 from the layer which is out of focus and from aberrations due to the non-ideal depth position of the in-focus layer.

FIG. 6 shows reflected light on a detector. A detector 61 of the four quadrant type is indicated schematically. The reflected light 62 contains out-of-focus stray light, which gives a shadow over the detector which is non-uniform in intensity.

FIG. 7 shows the focus error signal S-curve and focus offset. The nominal focus 72 is shown at the zero crossing. However the optimal focus offset, i.e. the best offset for minimizing jitter, is now shifted, either to a positive offset 71 or a negative offset 73. It is to be noted that not only stray light, but also other effects are influencing the best offset, such as a deviation of the nominal thickness of the transparent top layer. In an embodiment the focus area is provided with pre-recorded large single tone carriers having long marks (e.g. of a length of 11 channel bits, such as pits and lands I11-I11). The focus area is located in a predefined area, for example in the lead in zone and/or lead-out zone of the dual layer disc. Preferably every recording layer contains a focus area. In an embodiment the pregroove is modulated to constitute pregroove lands and pregroove pits that have the same groove depth as the pregroove for the data zone. Using the single tone carrier the maximum readout signal amplitude leads to about the optimal focus offset value for writing. In an embodiment the focus adjustment thus found is further improved by a short writing test to fine tune the focus-offset on jitter.

It is noted that since only the read signal is optimized the groove depth for the pre-recorded carrier pattern does not need to be optimized to provide the absolute maximum signal. Hence in the disc mastering conventional technology that is necessary to manufacture the pregroove can be used. In all cases studied up till now, maximum signal amplitude due to the long marks corresponds to about the right focus offset value.

FIG. 8 shows jitter values for a dual layer disc. Vertically the jitter values are indicated, and horizontally the readout signal values for indicating the maximum signal as a function of jitter on a dual layer disc. The upper curve 81 shows the jitter values for the L1 layer, and the lower curve 82 shows the jitter values for the L0 layer when reading the carrier pattern of long marks. It can be seen that the maximum signal values correspond to the best (i.e. lowest) jitter values on both layers. Several discs have been investigated: standard DVD+RW disc, DL ROM disc, dual layer DVD+RW disc, single layer L0 and L1+RW stacks, dual layer DVD+R disc, single layer L0 and L1+R stacks. In all cases, minimum jitter values were associated with high long mark pattern (e.g. I11 carrier) signal amplitude.

FIG. 9 shows a read signal as a function of focus-offset for the L1 layer of a dual layer disc. Vertically the read signal values are indicated, and horizontally the focus offset values for indicating the maximum signal as a function of focus offset on a dual layer disc. A first curve 91 indicated by gray triangles shows the read signal due to the long marks. A second curve 92 indicated by a dashed line shows a polynomial based on the first curve 91 which indicates that the maximum signal corresponds to an offset of about −1 Volt, which corresponds to the best offset as indicated in FIG. 10. A third curve 93 indicated by diamonds shows the push pull signal, while a polynomial based on that curve substantially covers the same signal values. No clear maximum can be found in the push-pull signal that can be used to find a best focus offset. Note that maximum push-pull signal is not directly correlated to the lowest jitter values due to aberrations caused by the non-optimal focus depth.

FIG. 10 shows the jitter as a function of focus-offset for the L1 layer of a dual layer disc. Vertically the jitter values are indicated, and horizontally the focus offset values. A bathtub curve 95 shows the jitter which corresponds to expected errors during data read-out as a function of focus offset on a dual layer disc. The best focus offset is around −1 Volt which corresponds to the middle of the bathtub shaped curve 95. As shown in FIG. 9 the best offset value corresponds to the maximum of the read-out signal due to the carrier pattern of long marks.

Although the invention has been mainly explained by embodiments using optical discs based on change of reflection, the invention is also suitable for other record carriers such as rectangular optical cards, magneto-optical discs or any other type of information storage system that has a pre-applied pattern on a writable record carrier. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Record carrier of a writable type for recording information by writing marks in a track on a recording layer via a beam of radiation entering through an entrance face of the record carrier and constituting a scanning spot having an effective diameter on the track,
the marks having lengths corresponding to an integer number of channel bit lengths T and the shortest marks having a length of a predefined minimum number d of channel bit lengths T for being detectable via the scanning spot having said effective diameter,
the recording layer comprising a pregroove (14) for indicating the track, the pregroove exhibiting a wobble constituted by displacements of the pregroove in a direction transverse to the longitudinal direction of the track, and the pregroove comprising a pregroove modulation of the depth and/or width of pregroove areas for constituting a carrier pattern containing long marks (18,19),
the long marks having lengths of at least two times the predefined minimum number d of channel bit lengths T for being substantially longer than the effective diameter of the scanning spot, and
the carrier pattern constituting a focus area (12) at a predefined location on the recording layer.

2. Record carrier as claimed in claim 1, wherein the pregroove modulation comprises pregroove land areas (19) of zero depth alternating with pregroove pit areas (18) of a predefined depth and width for constituting said carrier pattern.

3. Record carrier as claimed in claim 1, wherein the record carrier comprises at least a first recording layer (40) and a second recording layer (41), the first recording layer being present at a position closer to the entrance face than the second recording layer, and each recording layer having the focus pattern (12).

4. Record carrier as claimed in claim 3, wherein each recording layer comprises the focus pattern (12) at a substantially corresponding radial position.

5. Record carrier as claimed in claim 1, wherein the predefined minimum number d is 3 channel bit lengths T (d=3 T), and the long marks have lengths of at least 6 T, in particular the lengths being in the range of 8 T to 14 T.

6. Record carrier as claimed in claim 1, wherein the carrier pattern substantially only contains said long marks.

7. Record carrier as claimed in claim 1, wherein the pregroove modulation is representing additional information encoded by the long marks according to a predefined channel coding algorithm, which predefined channel coding algorithm differs from a channel coding algorithm representing said recorded information.

8. Device for scanning a track on a record carrier (11) via a beam of radiation (24), the track comprising marks on a recording layer, the beam entering through an entrance face of the record carrier and constituting a scanning spot having an effective diameter on the track, the marks having lengths corresponding to an integer number of channel bit lengths T and the shortest marks having a length of a predefined minimum number d of channel bit lengths T for being detectable via the scanning spot having said effective diameter, the recording layer comprising a pregroove for indicating the track, the pregroove exhibiting a wobble constituted by displacements of the pregroove in a direction transverse to the longitudinal direction of the track, and the pregroove comprising a pregroove modulation of the depth and/or width of pregroove areas for constituting a carrier pattern containing long marks, the long marks having lengths of at least two times the predefined minimum number d of channel bit lengths T for being substantially longer than the effective diameter of the scanning spot, and the carrier pattern constituting a focus area at a predefined location on the recording layer,
the device comprising
a head (22) for providing the beam,
focus servo means (25) for focusing the beam on the track for constituting said scanning spot,
a front-end unit (31) for generating a scanning signal (33) for detecting marks in the track, and
a focus adjustment unit (32) for locating the focus area and for adjusting the focus servo means in dependence on an amplitude of the scanning signal due to the carrier pattern during scanning the focus area.

9. Device as claimed in claim 8, wherein the focus servo means (25) are arranged for focusing on one of at least a first recording layer (40) and a second recording layer (41) in the record carrier, the first recording layer being present at a position closer to the entrance face than the second recording layer, and each recording layer having the focus pattern, and the focus adjustment unit (32) being arranged for, for each recording layer separately, locating the focus area and adjusting the focus servo means (25) in dependence on an amplitude of the scanning signal due to the carrier pattern during scanning the focus area of the respective layer.

10. Device as claimed in claim 8, wherein the focus adjustment unit (32) is arranged for writing a focus test pattern and for further adjusting the focus servo means (25) in dependence on jitter or errors detected during subsequently reading said test pattern.

11. Device as claimed in claim 8, wherein the device comprises a pregroove demodulation unit (34) for retrieving, from the scanning signal, additional information encoded in the pregroove modulation according to a predefined channel coding algorithm, which predefined channel coding algorithm differs from a channel coding algorithm representing said recorded information.
